(19) United States
(12) Patent Application Publication
(10) Pub. No.: US 2025/0290778 A1
(43) Pub. Date: Sep. 18, 2025

(54) METALIZED PLASTIC HEAT SHIELD ENCLOSURE FOR HEATED INLET MANIFOLD

(71) Applicant: Inficon Inc., East Syracuse, NY (US)

(72) Inventor: Bob Cady, Syracuse, NY (US)

(21) Appl. No.: 19/078,973

(22) Filed: Mar. 13, 2025

Related U.S. Application Data
(60) Provisional application No. 63/565,087, filed on Mar. 14, 2024.

(51) Int. Cl. G01D 11/24; G01N 27/62

(52) U.S. Cl. CPC G01D 11/24; G01N 27/62

(57) ABSTRACT

An insulated gas inlet assembly is provided including a gas inlet assembly disposed on an instrument manifold and a metalized enclosure at least partially disposed on at least one of the gas inlet assembly and the instrument manifold, wherein the metalized enclosure includes a metal layer disposed on a molded plastic shell. Also provided is a method for controlling the temperature of a residual gas analyzer including providing a residual gas analyzer with an instrument manifold and a gas inlet assembly with a gas inlet chassis; positioning the element on the gas inlet chassis, the heating element being thermally coupled to the gas inlet chassis; at least partially disposing a metalized enclosure on at least one of the gas inlet chassis and the instrument manifold; and directing an electrical current through a conduit into the heating element to generate a temperature gradient across the gas inlet chassis.

### CROSS REFERENCE TO RELATED APPLICATION(S)

The present application claims the benefit of and priority to U.S. Provisional 63/565,087 filed Mar. 14, 2024, title METALIZED PLASTIC HEAT SHIELD ENCLOSURE FOR HEATED INLET MANIFOLD, the entire contents of which are hereby incorporated by reference herein.

### FIELD OF THE INVENTION

The present invention relates to residual gas analyzers (RGA) used for applications including, but not limited to, semiconductor and display manufacturing. In particular, the present invention relates to residual gas analyzers with a heating element and a heat shield enclosure.

### BACKGROUND OF THE INVENTION

Residual gas analyzers (RGAs) play a multifaceted role in the semiconductor manufacturing domain. One of their primary functions lies in their ability to act as highly sensitive leak detectors. Semiconductor fabrication frequently involves a series of deposition and etching steps carried out within meticulously maintained vacuum chambers. Even the slightest breach in these chambers can lead to the intrusion of air, moisture, or other contaminants, potentially jeopardizing the intricate layers that form the basis of a semiconductor device. RGAs possess the capability to rapidly identify trace amounts of these unwanted gases, signaling the presence of a leak and prompting timely corrective measures. This safeguards precious time and resources, minimizing the risk of compromised batches of semiconductors.

In addition, RGAs are used to identify and monitor process contaminants in applications such as semiconductor and display fabrication processes. The fabrication of semiconductors often necessitates the use of reactive gases and chemical vapors as part of deposition, etching, and cleaning processes. RGAs are used to monitor residual gas composition within vacuum chambers, keeping track of the accumulation of these process gases or their byproducts. Such information provides a basis for chamber maintenance and cleaning cycles, and indicators for conditions indicating that a process step may not be performing as intended. Detecting such deviations is crucial for upholding product quality and ensuring the consistency of semiconductor devices.

The capabilities of RGAs extend into the realm of process optimization. By scrutinizing the evolution of gas compositions within vacuum chambers during a manufacturing process, engineers can glean a wealth of data. This data allows for the fine-tuning of critical parameters such as gas flow rates, the power levels used in plasma etching, or the timing of various process steps. The insights provided by RGAs empower manufacturers to boost their production yields while simultaneously enhancing the performance of the semiconductor devices they create.

Residual gas analyzers (RGAs) occupy a significant niche within the realm of analytical instrumentation, specifically in environments characterized by high and ultra-high vacuum conditions.

The initial step within an RGA involves the ionization of neutral gas molecules. In this process, a beam of electrons, typically generated via a thermionic emission filament, is accelerated towards the residual gas sample. Collisions between the energetic electrons and gas molecules result in the ejection of electrons from the gas molecules, yielding positively charged ions. The efficiency of the ionization process varies depending on the electron energy and the specific ionization cross-section of the gas species.

Following gas ionization, the RGA uses mass filtering to segregate ions according to their mass-to-charge ratio. Quadrupole mass filters represent the most widely utilized type of mass filter in RGAs. A quadrupole mass filter comprises four parallel cylindrical rods arranged in a square configuration. Radiofrequency (RF) and direct current (DC) voltages are superimposed on opposing pairs of rods, generating a complex oscillating electric field within the quadrupole assembly. Only ions possessing a specific m/z ratio will maintain a stable trajectory through the quadrupole filter under the influence of the applied voltages. By systematically varying the RF and DC voltages, the quadrupole can function as a mass spectrometer, sequentially allowing ions of different m/z ratios to pass through the filter.

Upon exiting the mass filter, ions impinge upon a detector. Faraday cups and electron multipliers are the two primary types of detectors used in RGAs. A Faraday cup operates on the principle of direct charge collection. Ions striking the Faraday cup induce a small electrical current, the magnitude of which is proportional to the abundance of the ions. Electron multipliers, on the other hand, utilize a series of dynodes to amplify the ion signal through secondary electron emission. This amplification process affords electron multipliers superior sensitivity compared to Faraday cups.

The output from the RGA detector is an electrical signal that fluctuates as a function of the scanned mass-to-charge ratios. This signal is amplified, digitized, and processed by a computer system. The resulting mass spectrum displays the relative abundance of ions as a function of their mass-to-charge ratio, providing a qualitative and quantitative fingerprint of the residual gas composition.

Semiconductor process heats gas for process chemistry. If the hot gas enters the cold inlet, process byproducts can condense in the inlet or on the sensor. When sampling gases from certain semiconductor processes, the gas sample needs to remain hot to prevent deposition or contamination to the inlet and sensor. Without a means for maintaining gas sample temperatures above a threshold, such unwanted deposition can clog flow paths and damage the sensor.

Current solutions use a heater jacket that wraps around the outside of the instrument. This leads to cold spots from both insufficient surface contact between the inlet and jacket, as well as unpredictable internal temperature variations due to the poor thermal conductivity of steel. Moreover, use of a heater jacket requires the dedication of space where the objective is to achieve compact RGA instrument designs. External heating jackets also use rubber compounds that can outgas and create particles that are undesirable in a clean room environment. Moreover, external heating jackets can have cold spots due to poor thermal conductivity of steel. Current technologies that utilize other solutions with internal heaters mounted on or in the gas inlet chassis allow for heating only one gas flow path corresponding to one gas sample pressure.

As a result, there remains a need for gas inlet assembly designs that can ensure elevated temperatures are maintained for one or more gas paths through the gas inlet assembly controlled by inline gas valves. Such designs allow gas flows at different pressures through the RGA instrument and also provide for calibration with reference gas sources are desirable.

### SUMMARY OF THE INVENTION

Disclosed is an insulated gas inlet assembly, comprising a gas inlet assembly disposed on the instrument manifold and a metalized enclosure at least partially disposed on the gas inlet assembly. Further disclosed, the metalized enclosure may further comprise one or a plurality of heating elements thermally disposed on the gas inlet chassis; a metal layer disposed on a molded plastic shell; a metal layer bonded to a molded plastic shell; and/or an insulator layer disposed between the metal layer and the molded plastic shell, or any combination thereof.

Also disclosed is an insulated instrument manifold assembly, comprising an instrument manifold, and a metalized enclosure at least partially disposed on the gas inlet assembly or instrument manifold. Further disclosed is that the metalized may further comprise one or a plurality of heating elements thermally disposed on the gas inlet chassis; a metal layer disposed on a molded plastic shell; a metal layer bonded to a molded plastic shell; and/or an insulator layer disposed between the metal layer and the molded plastic shell, or any combination thereof.

Further disclosed is a residual gas analyzer, comprising an instrument manifold, a gas inlet assembly disposed on the instrument manifold, and a metalized enclosure at least partially disposed on the gas inlet chassis, partially disposed on the instrument manifold, or a combination thereof. Further disclosed is that the metalized enclosure may further comprise one or a plurality of heating elements thermally disposed on the gas inlet chassis; a metal layer disposed on a molded plastic shell; a metal layer bonded to a molded plastic shell; and or an insulator layer disposed between the metal layer and the molded plastic shell.

Further disclosed is a method for controlling the temperature of a residual gas analyzer, comprising providing a residual gas analyzer, an instrument manifold, a gas inlet assembly disposed on the instrument manifold, a heating element thermally disposed on the gas inlet chassis, and a metalized enclosure at least partially disposed on the gas inlet chassis, partially disposed on the instrument manifold, or a combination thereof; and, directing an electrical current through a conduit into at least one heating element to generate a temperature gradient across the gas inlet chassis. Further disclosed is that the electrical current to the heating element may be adjusted by a controller.

Further disclosed is an apparatus for maintaining increased process gas temperature in a residual gas analyzer, comprising a means for heating a gas inlet chassis, instrument manifold, or a combination thereof and a metalized enclosure at least partially disposed on the gas inlet chassis, instrument manifold, or a combination thereof to prevent the loss of heat. Further disclosed is that the metalized enclosure may further comprise a metal layer disposed on a molded plastic shell.

Further disclosed is a method for manufacturing a metalized enclosure for maintaining increased process gas temperature in a residual gas analyzer, comprising providing an injection molded plastic shell within inside surface and disposing a metal on the inner surface of the molded plastic shell. Further disclosed is that the metal is aluminum or an aluminum alloy; the plastic enclosure comprises acrylic, acrylonitrile butadiene styrene, nylon, polycarbonate, polyethylene, polyoxymethylene, polypropylene, polystyrene, thermoplastic elastomer or thermoplastic polyurethane, or a combination thereof; the metal may be disposed on the inner surface of the molded plastic shell by physical vapor deposition; and/or the metal may be disposed on the inner surface of the molded plastic shell by chemical vapor deposition.

In one exemplary embodiment, a residual gas analyzer includes an instrument manifold, a gas inlet assembly disposed on the instrument manifold, and a metalized enclosure at least partially disposed on at least one of the gas inlet assembly and the instrument manifold, wherein the metalized enclosure includes a metal layer disposed on a plastic shell.

In some embodiments, the residual gas analyzer further includes at least one heating element thermally disposed in the gas inlet.

In some cases, the metalized enclosure further includes an insulator layer disposed between the metal layer and the molded plastic shell.

In certain embodiments, the metalized enclosure is at least partially disposed on the gas inlet assembly. In additional embodiments, the metalized enclosure is at least partially disposed on the instrument manifold.

In some embodiments, the metalized enclosure is substantially free of a bonding material.

In certain embodiments, the plastic shell is a molded plastic shell.

The metal layer may be disposed on the plastic shell via one of a physical vapor deposition and a chemical vapor deposition.

The metal layer may be made with aluminum or an aluminum alloy. The plastic shell may be made with acrylic, acrylonitrile butadiene styrene, nylon, polycarbonate, polyethylene, polyoxymethylene, polypropylene, polystyrene, thermoplastic elastomer or thermoplastic polyurethane, or a combination thereof.

In some embodiments, the metalized enclosure is positioned at a distance from an external surface of the gas inlet assembly and/or an external surface of the instrument manifold.

An apparatus for maintaining an increased process gas temperature in a residual gas analyzer is further provided, including at least one heating element disposed on at least one of a gas inlet chassis and an instrument manifold; and a metalized enclosure at least partially disposed on at least one of the gas inlet chassis and the instrument manifold to prevent the loss of heat. The metalized enclosure includes a metal layer disposed on a plastic shell. and the at least one heating element is spaced apart from the metalized disclosure.

In some embodiments, the metalized enclosure includes a metalized gas inlet enclosure and a metalized instrument manifold enclosure, and the apparatus further includes at least one connector for removably coupling the metalized gas inlet enclosure and the metalized instrument manifold enclosure.

In certain embodiments, the metalized enclosure is substantially free of a bonding material.

Further provided is a method for controlling the temperature of a residual gas analyzer, including the steps of providing a residual gas analyzer with an instrument manifold and a gas inlet assembly disposed on the instrument manifold, wherein the gas inlet assembly has a gas inlet chassis; positioning at least one heating element on the gas inlet chassis, the at least one heating element being thermally coupled to the gas inlet chassis; at least partially disposing a metalized enclosure on at least one of the gas inlet chassis and the instrument manifold; and directing an electrical current through a conduit into the at least one heating element to generate a temperature gradient across the gas inlet chassis.

In some embodiments, the electrical current to the at least one heating element is adjusted by a controller.

In certain embodiments, the metalized enclosure is positioned at a distance from the gas inlet assembly and/or the instrument manifold.

In some embodiments, the method also includes the steps of providing an injection molded plastic shell with an inner surface and disposing a metal on the inner surface of the molded plastic shell to produce the metalized enclosure.

In some of these embodiments, the metal is disposed on the inner surface of the molded plastic shell by physical vapor deposition. In additional embodiments, the metal is disposed on the inner surface of the molded plastic shell by chemical vapor deposition.

### BRIEF DESCRIPTION OF DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 illustrates exemplary components of a fabrication process including a residual gas analyzer and a gas inlet assembly in accordance with one or more illustrative embodiments of the present invention.

FIG. 2 shows a perspective view of a residual gas analyzer including a gas inlet assembly in accordance with one or more illustrative embodiments of the present invention.

FIG. 3 shows a block diagram of a gas inlet assembly in accordance with one or more illustrative embodiments of the present invention.

FIG. 4 shows a cross-sectional view of a heating jacket in accordance with one or more illustrative embodiments of the present invention.

FIG. 5 shows a perspective view of a heating in accordance with one or more illustrative embodiments of the present invention.

FIG. 6A shows a cross-sectional view of exemplary components of a metalized enclosure for a gas inlet assembly in accordance with one or more illustrative embodiments of the present invention.

FIG. 6B shows a cross-sectional view of exemplary components of a metalized enclosure for an instrument manifold in accordance with one or more illustrative embodiments of the present invention.

FIG. 7A illustrates an exemplary cross-sectional diagram of a section of a two-layer metalized shell in accordance with one or more illustrative embodiments of the present invention.

FIG. 7B illustrates an exemplary cross-sectional diagram of a section of a three-layer metalized enclosure in accordance with one or more illustrative embodiments of the present invention.

FIG. 7C illustrates an exemplary cross-sectional diagram of a section of a multi-layer metalized enclosure in accordance with one or more illustrative embodiments of the present invention.

FIG. 8 shows a plot of simulated data for the temperature distribution in a longitudinal cross-sectional diagram of an exemplary gas inlet assembly and manifold comprising a heating element disposed in the gas inlet chassis with an installed metalized enclosure in accordance with one or more illustrative embodiments of the present invention.

FIG. 9 shows a plot of simulated data for the temperature distribution in a longitudinal cross-sectional diagram of an exemplary gas inlet assembly and manifold comprising a heating element disposed in the gas inlet chassis with an installed metalized enclosure illustrating convective heat reflection in accordance with one or more illustrative embodiments of the present invention.

FIG. 10A shows a horizontal cross-sectional view of a residual gas analyzer including a gas inlet assembly and an instrument manifold with a metalized cover in accordance with one or more illustrative embodiments of the present invention.

FIG. 10B shows a vertical cross-sectional view of the residual gas analyzer of FIG. 10A including the instrument manifold with the metalized cover.

### DETAILED DESCRIPTION

The inventors have surprisingly discovered that a heating element can be integrated in a gas inlet path assembly with multiple gas paths, thus eliminating the need for a heater jacket. Such an approach to gas inlet assembly design allows flexibility to sample multiple pressures by drawing gasses down different flow paths. In some exemplary embodiments, the gas inlet chassis may be heated by an integrated cartridge heater that is bored into the center of the inlet, thus allowing the source of heat to be directly adjacent to the gas flow paths. Temperature measurements may be taken internal to the gas inlet chassis as well and the temperature can be controlled and monitored using a controller, thus reducing cold spots and ensuring that heat is delivered to optimize the production of heated gas samples to the mass spectrometer. Integrated control ensures the correct temperature, and the temperature can be changed depending upon the application.

Many gas phase fabrication and processing configurations benefit from the addition of a Residual Gas Analyzer (RGA) typically including a quadrupole mass spectrometer. As quadrupole gas analyzer technology becomes more affordable, RGAs are becoming commonplace in all industries that require strict control of contamination levels in process gases such as semiconductor and display processing. For example, in the semiconductor industry, RGAs are best used in evaporators, sputterers, etchers or any other high vacuum systems that are routinely pumped down to pressures below 10⁻⁵ Torr to check the integrity of the vacuum seals and the quality of the vacuum before any wafers are committed to processing. Air leaks, virtual leaks and many other contaminants at very low levels can ruin wafers and must be detected before a process is started. As the semiconductor processes become more sophisticated, likewise the processes become less tolerant to contaminants. Residual gas analysis in a process chamber increases up-time and production yield and reduces cost of ownership.

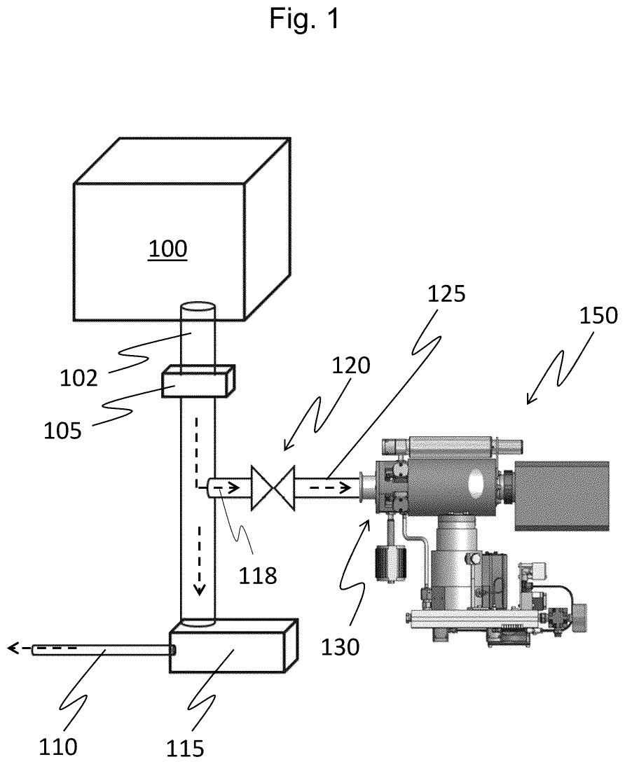

FIG. 1 shows an exemplary functional block diagram for a gas phase vacuum process incorporating a residual gas analyzer 150. The process chamber 100 is connected to the vacuum pump 115 by an exhaust conduit 102 that may include a throttle valve 105. Exhaust gas from the pump is delivered to an exhaust conduit 110 to a scrubber (not shown) to remove harmful pollutants from industrial exhaust gases before they are released into the atmosphere. A gas flow stream is diverted 118 to the RGA gas inlet conduit (equivalently, gas inlet conduit or inlet conduit) 125, possibly through one or more isolation valves 120. The diverted gas flow passes through a gas inlet assembly 130 into the residual gas analyzer instrument.

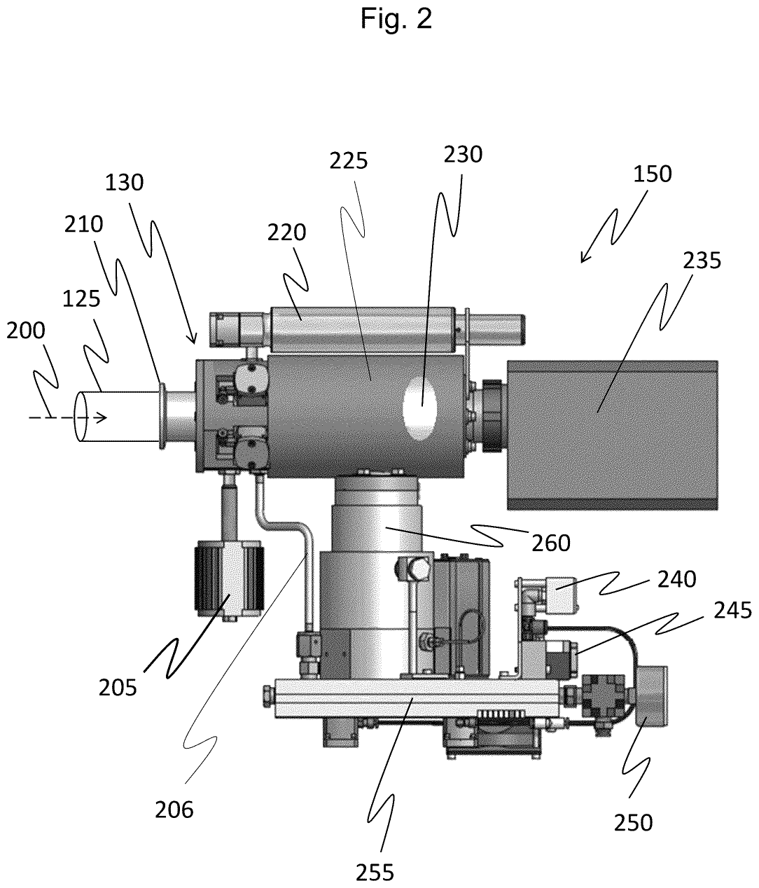

FIG. 2 shows a perspective view of an exemplary residual gas analyzer 150 including a gas inlet assembly in accordance with one or more illustrative embodiments of the present disclosure. Sample process gas flow 200 from the process chamber (not shown) is directed through the gas inlet conduit 125. The gas inlet conduit 125 is attached to the gas inlet assembly 130 by the process connector 210. Also attached to the gas inlet assembly 130 may be a process pressure gauge 205 (for example, a capacitance pressure gauge (CDG), an accurate temperature manometer), a calibration reference 220, and/or a bypass connection 206. Process sample gas flows through the gas inlet assembly 130 into the sensor manifold 225, which includes the compact process monitoring (CPM) emission sensor. In existing technology, the sensor manifold 225 (equivalently, instrument manifold) may be encased by a heater jacket to heat the gas flow indirectly through conduction and convection. The operation of the sensor and mass spectroscopy instrumentation is controlled and processed by the CPM electronics module 235. Gas flow is driven by a turbo molecular pump 260 which may be controlled by dedicated embedded electronics in communication with the CPM electronics modules, in conjunction with a pressure switch 240, valve solenoids 245 that control the pneumatics on the gas inlet assembly, and a nitrogen regulator 250. The RGA is physically supported by an integrated fore line block 255.

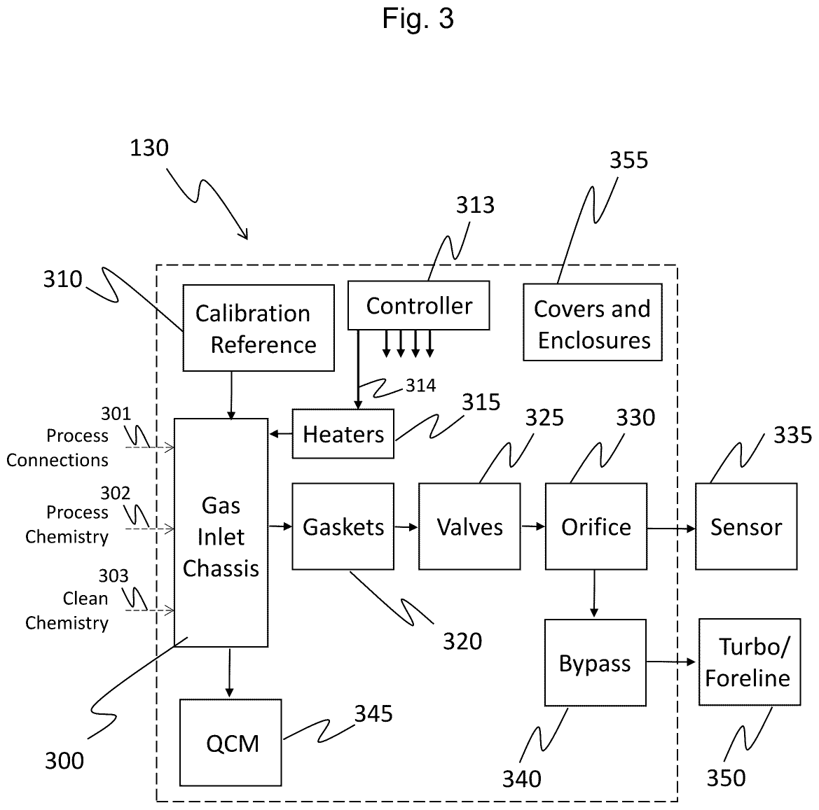

FIG. 3 shows a functional block diagram of an exemplary embodiment of a gas inlet assembly 130 including several key components. The gas inlet chassis 300 receives the process connections 301, the process chemistry 302 and the clean chemistry 303 through the gas flow entering the through the gas inlet conduit. The calibration reference 310 and the Quartz Crystal Microbalance (QCM) 345 operate through their flow connection to the gas path traversing the gas inlet chassis 300. The CPM mass spectrometer sensor 335 is in flow communication with the gas inlet chassis 300 through an assembly comprising gaskets 320, valves 325 and an orifice 330 designed to couple the gas flow and limit the pressure to the CPM sensor 335. The temperature of the gas path(s) may be managed using one or a plurality of heater(s) 315 managed by a controller 313 through an electrical connection 314, which may also control other RGA functions. The orifice 330 may also bleed gas flow to a bypass 340 to a vacuum pump 350, in some embodiments may be a diaphragm pump. In some embodiment, the gas inlet assembly may be protected by one or a plurality of covers 355 or enclosures.

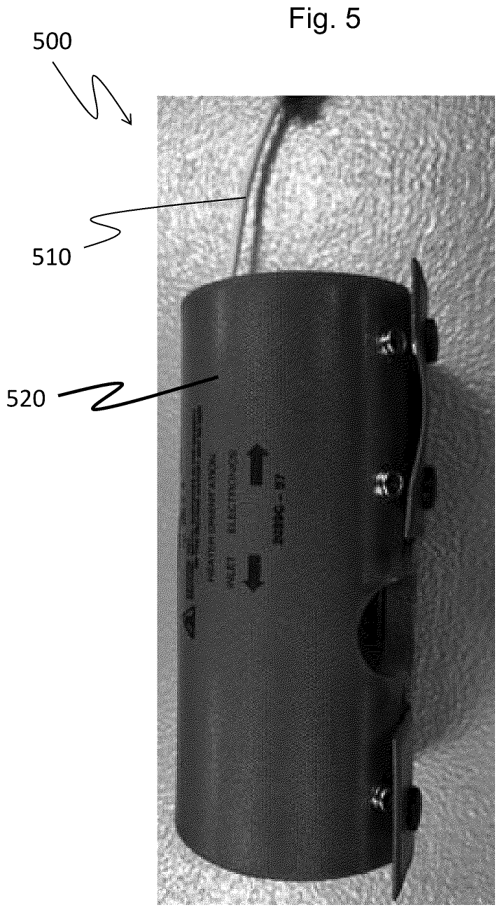

The inlet and sensor manifolds for the mass spectrometer are heated for bakeout and high temperature operation. The heat needs to be evenly distributed, and the hot metal needs to be covered to prevent contact with people that could be burned. Various covers or enclosures 355 for insulating all or part of the gas inlet assembly 130 from FIG. 1, and/or all or part of the instrument manifold 230 from FIG. 2 containing the sensor 355 (from FIG. 3) are known. FIG. 5 shows one such removable cover 500, where an electrical conduit 510 connects a power supply to an electrical heating element (not shown) located in the insulative cover 520. The insulative cover 520 is made of silicon rubber. There are a number of problems associated with this type of cover. The rubber can outgas, deteriorate and even melt if the heating elements are too hot. Such covers are typically limited to 150° C. and even at that temperature can experience occasional failures.

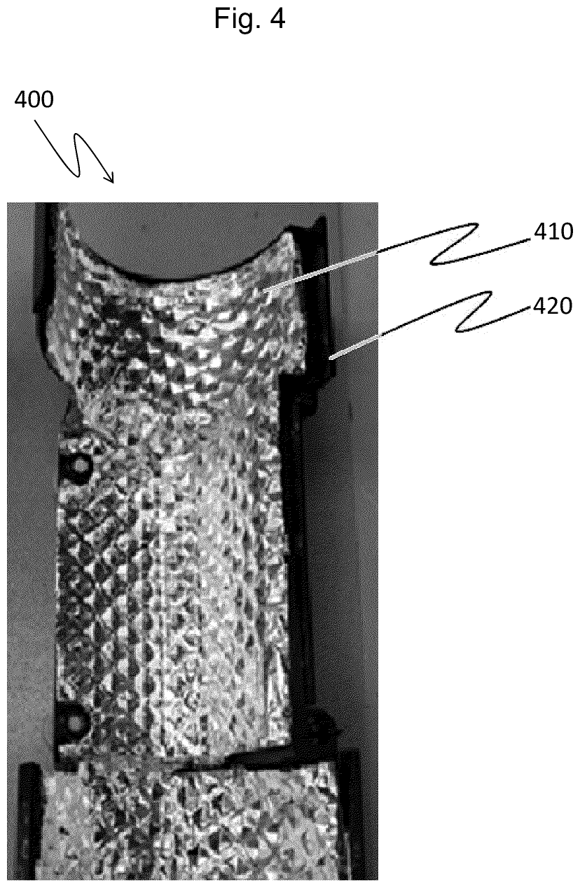

FIG. 4 shows another type of enclosure 400 including metal thermal shield 410 bonded to a molded plastic shell 420, typically using an epoxy adhesive. The heating element may be incorporated into the gas inlet assemble and/or the instrument manifold, or a combination thereof. In such solutions, the glued in insulation can also outgas and generate particles that are problematic in clean room environments. Also, there are quality problems due to difficulty with the gluing process.

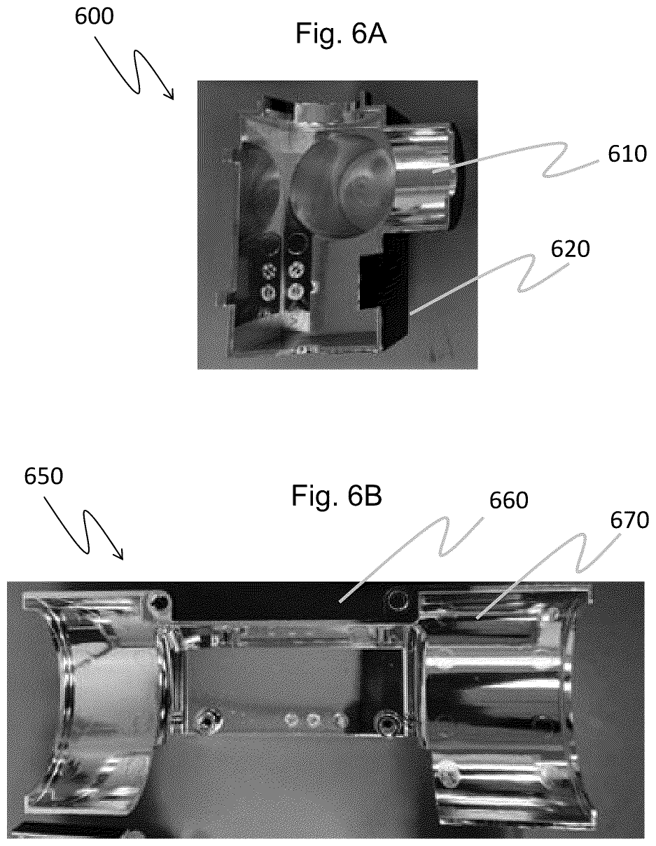

The inventors have surprisingly discovered a metalized enclosure that mitigates the ill-effects of bonding a metal insulator to a plastic shell and better controls the heat retention and insulative effects of the cover for heat retention and insulation. The inventive metalized enclosure may be used to insulate all or part of the gas inlet assembly 130, all or part of the instrument manifold 225 containing the sensor 355, or a combination thereof, wherein the gas inlet assembly 130 and/or the instrument manifold 225 contains a heating element. FIG. 6A shows an exemplary embodiment of a metalized enclosure 600 for a gas inlet assembly comprising a metal layer 610 disposed on a molded plastic shell 620. FIG. 6B shows an exemplary embodiment of a metalized enclosure 650 for an instrument manifold comprising a metal layer 660 disposed on a molded plastic shell 670. The inventive cover relies on the air gap between the cover and sensor as insulation and uses the metalized coating as a heat reflective shield. The inventive cover allows the sensor manifold to be heated up to about 160° C.-200° C. and preferably about 180° C., while an external temperature of the plastic cover is kept at about 50° C.-90° C., and preferably about 70° C.

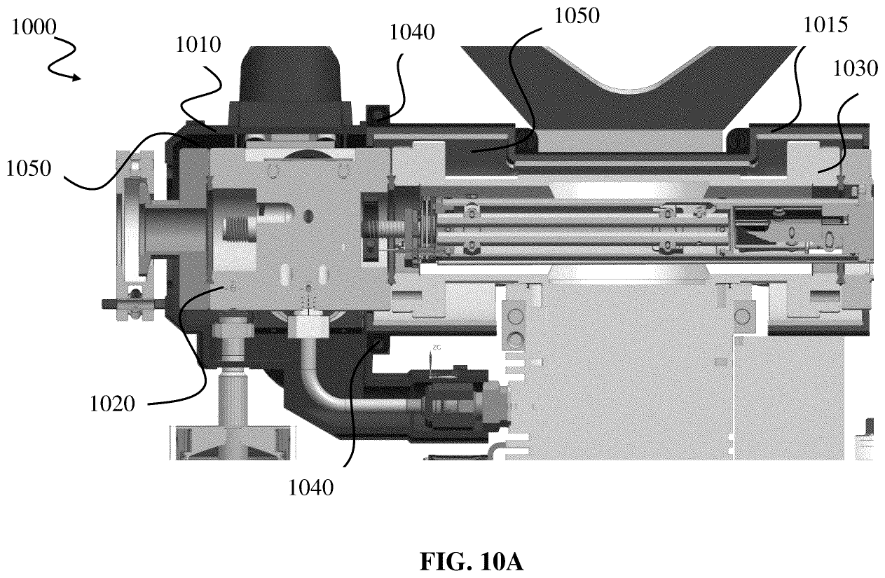

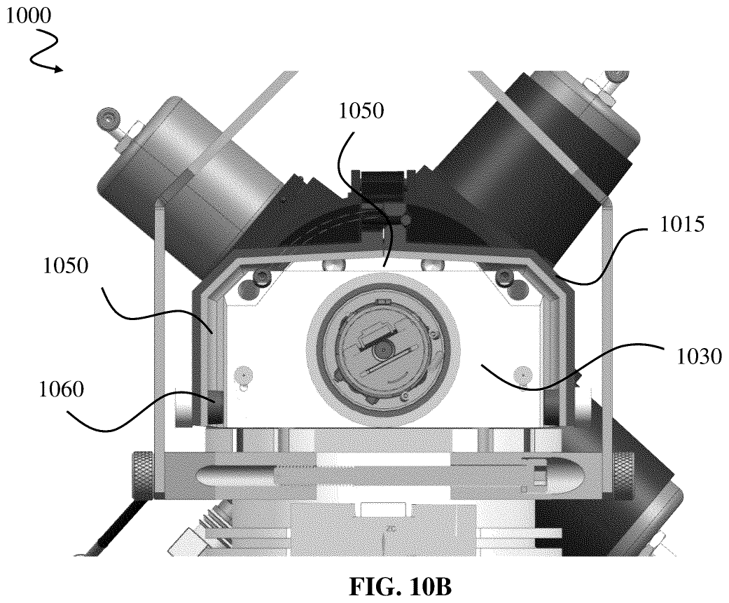

FIGS. 10A and 10B illustrate a metalized enclosure of the present invention positioned on the residual gas analyzer (RGA) 1000. The RGA 100 includes a gas inlet assembly 1020 and the instrument/sensor manifold 1030. The gas inlet assembly cover 1010 is positioned over the gas inlet assembly 1020 and the instrument manifold cover 1015 is positioned over the instrument manifold 1030. In some embodiments, the gas inlet assembly cover 1010 and the instrument manifold cover 1015 are coupled together to provide a continuous heat shield. The covers 1010 and 1015 may be coupled by any suitable means, such as snaps 1040 and the like, that allow for removable coupling of the two covers.

In preferred embodiments, the cover 1010 and/or cover 1015 are positioned on the gas inlet assembly and/or the instrument manifold such that there is an air gap 1050 provided between the outer/external surface of the gas inlet assembly and the instrument manifold and the inner surface of the cover 1010, 1015. This may be accomplished by providing raised connectors 1060, as shown in FIG. 10B, between the cover 1010, 1015 and the outer surface of the gas inlet/instrument manifold. It is understood that other means for providing the air gap are contemplated within the scope of the invention. The air gap 1050 facilitates conduction and convection of heat energy emanating from the gal inlet and the instrument manifold that is reflected by the metalized enclosure/cover, thus improving the heat shielding and insulative properties of the enclosure.

In an exemplary embodiment, the plastic shell may be manufactured by injection molding. Injection molding is a cyclic manufacturing process used to produce high volumes of identical plastic parts. The process begins with thermoplastic pellets being fed into a heated barrel. There, a reciprocating screw melts and mixes the material. This molten plastic is then injected under high pressure into a precisely machined mold cavity where it cools and solidifies. The mold splits, ejecting the finished part. The key steps in a typical injection molding cycle include clamping, injection, packing/holding, cooling, and ejection. The injection molding process is known by those skilled in the art for its ability to produce complex parts.

A plastic shell for a metalized enclosure may be comprised of a variety of materials including, but not limited to, acrylic (PMMA), acrylonitrile butadiene styrene (ABS), nylon (polyamide, PA), polycarbonate (PC), polyethylene (PE), polyoxymethylene (POM), polypropylene (PP), polystyrene (PS), thermoplastic elastomer (TPE), and/or thermoplastic polyurethane (TPU), or a combination thereof.

Not to be bound by theory, the metal surface for the metalized enclosure can be disposed on the plastic shell by a variety of methods including physical vapor deposition (PVD), a collection of vacuum deposition techniques used to create thin films on substrates. PVD metallization creates a reflective heat shield enclosure around the heated parts that forms an ‘oven’ to reflect infrared radiation back onto heated metal components, creates an enclosure to reduce convective cooling affects, utilizes trapped air as insulation, and protects heated metal from incidental contact that could result in burns. In PVD, a solid source material is transitioned to a vapor phase through physical means such as thermal evaporation or sputtering. This vapor then condenses onto the substrate, forming a thin, highly controlled film. PVD processes are utilized to deposit a variety of materials including metals, alloys, and ceramics. These coatings enhance properties such as wear resistance, corrosion resistance, conductivity, and optical characteristics. PVD is widely employed in industries like electronics, optics, tooling, and medical devices.

Chemical vapor deposition (CVD) may also be used to create the metal surface of the metalized enclosure, a process that can deposit thin, solid films on a substrate through the chemical reactions of gaseous precursors. The precursors are introduced into a reaction chamber, often under vacuum, where they are heated and undergo reactions either on the substrate surface or in the gas phase. The reaction products then deposit on the substrate, forming the desired film. Other known manufacturing processes for applying a metalized layer to a plastic cover may also be utilized in accordance with the present invention.

In exemplary embodiments, the metal surface for the metalized enclosure may be comprised of any metal with good thermal shielding and reflectivity properties that is also amenable to a vapor disposition manufacturing process. The desirable metal materials may produce surfaces with about 70% to about 95% reflectivity, and preferably up to about 90% reflectivity. In some embodiments, the metal may be aluminum and its alloys. In additional embodiments, the metal may be titanium (Ti), chromium (Cr), copper (Cu), nickel (Ni) and stainless steel, and/or alloys of these metals. Any combination of these materials may also be used. In some preferred embodiments, the metal used is aluminum.

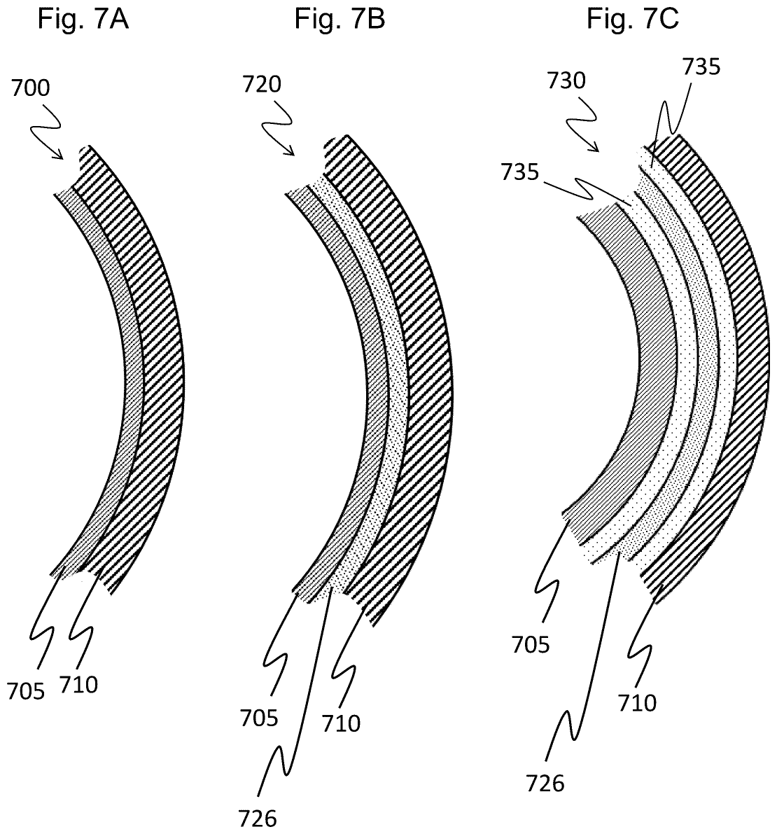

Moreover, metalized enclosures with two or more layers are contemplated and disclosed. FIG. 7A shows a cross-sectional view of an exemplary embodiment of a metalized enclosure 700 comprising a metal layer 705 disposed on a plastic shell 710. In some embodiments, the metalized enclosure of the present invention is free or substantially free of adhesive or bonding material, such as epoxy. FIG. 7B shows a cross-sectional view of an exemplary embodiment of a three-layer metalized enclosure 720 comprising a metal layer 705 disposed on a plastic shell 710 and separated by an insulative layer 726 directly deposited on the metal and plastic surfaces. The insulative layer 726 may use any suitable insulative material, including but not limited to closed cell foam or fiberglass. FIG. 7C shows a cross-sectional view of an exemplary embodiment of a multi-layer metalized enclosure 730 comprising a metal layer 705 disposed on a plastic shell 710 separated by an insulative layer 726 deposited between the metal and plastic surfaces, that may also include a bonding material 735 to attach the metal, insulative and plastics surfaces together. Any suitable bonding material may be used, such as two-part epoxy or pressure sensitive adhesive. A thickness of the plastic shell 710 may be about 2 mm-3 mm, or about 2.5 mm. A thickness of the metal layer 705 may be about 0.05 mm to about 0.2 mm or about 0.1 mm to about 0.15 mm. A thickness of the insulative layer 726 may be about 1 mm to about 5 mm, or about 2 mm. A total thickness of the metalized enclosure of the present application may be between about 2 mm to about 8 mm, or about 2.5 mm to about 4.5 mm.

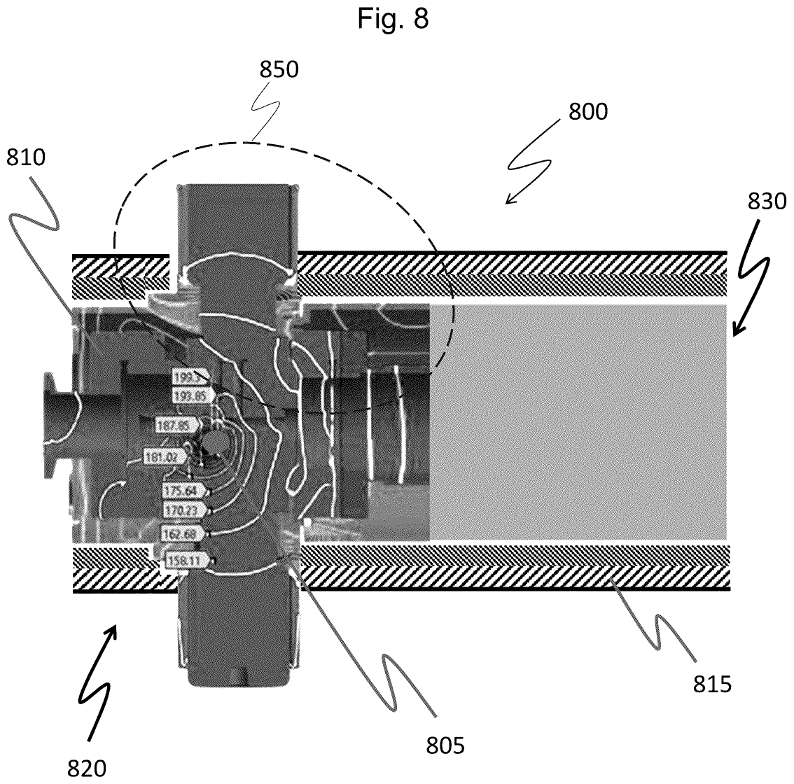

FIG. 8 shows a plot of simulated data for the temperature distribution in a longitudinal cross-sectional diagram of a gas inlet assembly comprising a heating element disposed in the gas inlet chassis in accordance with one or more illustrative embodiments of the present disclosure. The exemplary embodiment simulation 800 displays contour lines of equal temperature along the thermal gradient in the equilibrium condition created by the heating element 805 disposed in the gas inlet chassis 810. Simulated results for the embodiment shown shows a temperature gradient is created by the heating element from approximately 188 degrees Centigrade (188° C.) near the heating element 805 to approximately 158 degrees Centigrade (158° C.) near the surface of the gas inlet chassis 810. A metalized enclosure 815 surrounds the gas inlet assembly 820 and the instrument manifold 830 with the inlet chassis 810, acting as an insulator and heat shield around the inlet chassis so that the surface temperature of the plastic cover (where it could be contacted by a person) is about 60-70° C. at the hottest parts. A region 850 of the gas inlet assembly with the metalized enclosure used to reduce the heat loss from RGA is shown.

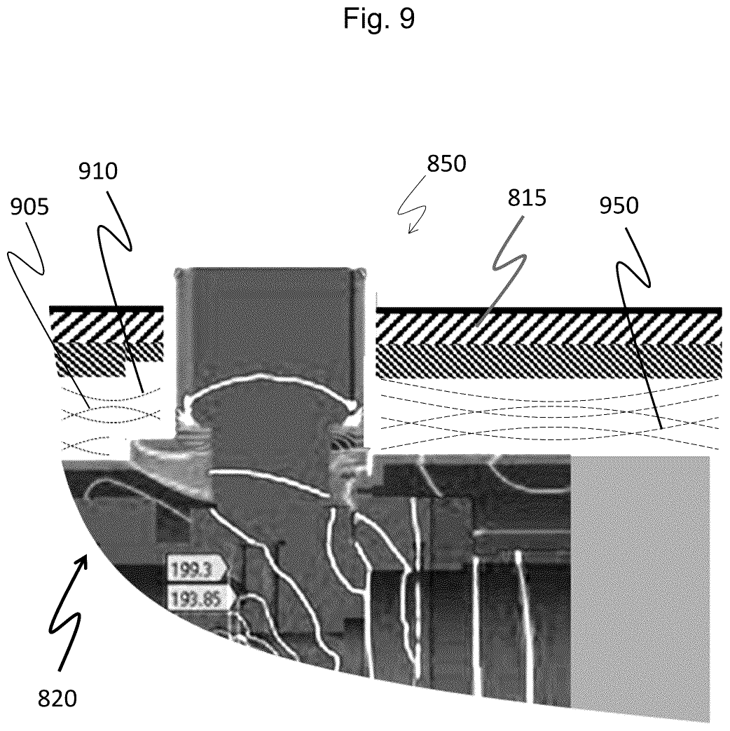

FIG. 9 shows an expanded view of the region 850 shown on FIG. 8 of the gas inlet assembly with the metalized enclosure 815 used to reduce the heat loss from RGA in FIG. 8. Heat energy emanating 905 from the gas inlet assembly 820 is reflected and transferred 910 back to the gas inlet chassis by conduction and convection within the airspace 950 provided between the outer surface of the inlet gas assembly 820 and the metalized enclosure 815. The temperature distribution results shown in FIGS. 8 and 9 were obtained at ambient environment (about 26° C.).

The disclosed invention obviates the need for external heating jackets that can exhibit cold spots due to poor thermal conductivity of steel and contain silicone rubber and adhesives that may outgas and create particulates that are problematic in a clean room environment. Moreover, the exemplary embodiments describe an enclosure rather than insulation jacket and use vacuum metallization to create a heat shield/heat reflector.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The term “about” is to be construed as modifying a term or value such that it is not an absolute. This term will be defined by the circumstances. This includes, at the very least, the degree of expected experimental error, technique error and instrument error for a given technique used to measure a value. In general, this term used in connection with a numerical value throughout the specification and the claims denotes an interval of accuracy, familiar and acceptable to a person skilled in the art. In general, such interval of accuracy is +10%. Thus, “about ten” means 9 to 11. All numbers in this description indicating amounts, ratios of materials, physical properties of materials, and/or use are to be understood as modified by the word “about,” except as otherwise explicitly indicated.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

1. A residual gas analyzer, comprising:
an instrument manifold;
a gas inlet assembly disposed on the instrument manifold; and
a metalized enclosure at least partially disposed on at least one of the gas inlet assembly and the instrument manifold;
wherein the metalized enclosure comprises a metal layer disposed on a plastic shell.

2. The residual gas analyzer of claim 1, further comprising at least one heating element thermally disposed in the gas inlet.

3. The residual gas analyzer of claim 1, wherein the metalized enclosure further comprises an insulator layer disposed between the metal layer and the molded plastic shell.

4. The residual gas analyzer of claim 1, wherein the metalized enclosure is at least partially disposed on the gas inlet assembly.

5. The residual gas analyzer of claim 1, wherein the metalized enclosure is at least partially disposed on the instrument manifold.

6. The residual gas analyzer of claim 1, wherein the metalized enclosure is substantially free of a bonding material.

7. The residual gas analyzer of claim 1, wherein the plastic shell is a molded plastic shell.

8. The residual gas analyzer of claim 1, wherein the metal layer is disposed on the plastic shell via one of physical vapor deposition and chemical vapor deposition.

9. The residual gas analyzer of claim 1, wherein the metal layer comprises aluminum or an aluminum alloy.

10. The residual gas analyzer of claim 1, wherein the plastic shell comprises acrylic, acrylonitrile butadiene styrene, nylon, polycarbonate, polyethylene, polyoxymethylene, polypropylene, polystyrene, thermoplastic elastomer or thermoplastic polyurethane, or a combination thereof.

11. The residual gas analyzer of claim 1, wherein the metalized enclosure is positioned at a distance from an external surface of the gas inlet assembly and/or an external surface of the instrument manifold.

12. An apparatus for maintaining an increased process gas temperature in a residual gas analyzer, comprising:
at least one heating element disposed on at least one of a gas inlet chassis and an instrument manifold; and
a metalized enclosure at least partially disposed on at least one of the gas inlet chassis and the instrument manifold to prevent the loss of heat;
wherein the metalized enclosure comprises a metal layer disposed on a plastic shell; and
wherein the at least one heating element is spaced apart from the metalized disclosure.

13. The apparatus of claim 12, wherein the metalized enclosure comprises a metalized gas inlet enclosure and a metalized instrument manifold enclosure, and wherein the apparatus further comprises at least one connector for removably coupling the metalized gas inlet enclosure and the metalized instrument manifold enclosure.

14. The apparatus of claim 12, wherein the metalized enclosure is substantially free of a bonding material.

15. A method for controlling the temperature of a residual gas analyzer, comprising:
providing a residual gas analyzer comprising an instrument manifold and a gas inlet assembly disposed on the instrument manifold, wherein the gas inlet assembly comprises a gas inlet chassis;
positioning at least one heating element on the gas inlet chassis, the at least one heating element being thermally coupled to the gas inlet chassis;
at least partially disposing a metalized enclosure on at least one of the gas inlet chassis and the instrument manifold; and
directing an electrical current through a conduit into the at least one heating element to generate a temperature gradient across the gas inlet chassis.

16. The method of claim 15, wherein the electrical current to the at least one heating element is adjusted by a controller.

17. The method of claim 15, wherein the metalized enclosure is positioned at a distance from the gas inlet assembly and/or the instrument manifold.

18. The method of claim 15, further comprising the steps of:
providing an injection molded plastic shell with an inner surface; and
disposing a metal on the inner surface of the molded plastic shell to produce the metalized enclosure.

19. The method of claim 18, wherein the metal is disposed on the inner surface of the molded plastic shell by physical vapor deposition.

20. The method of claim 18, wherein the metal is disposed on the inner surface of the molded plastic shell by chemical vapor deposition.
